(19) United States
(12) Patent Application Publication
(10) Pub. No.: US 2003/0150995 A1
(43) Pub. Date: Aug. 14, 2003

(54) Integrated semiconductor-based spectrometric detection system

(76) Inventors: Loick Verger, Gremorle (FR); Jacques Rustique, Seyssinet (FR); Jean-Pierre Rostaing, La Cote Saint Audre (FR); Patrice Ouvrier-Buffet, St Jorioz (FR)

Correspondence Address: Robert E. Krebs, THELEN REID & PRIEST LLP, P.O. Box 640640, San Jose, CA, 95164-0640, US

(21) Appl. No.: 10/327,703

(22) Filed: Dec. 20, 2002

(30) Foreign Application Priority Data
Dec. 20, 2001 (FR) 01 16550

(51) Int. Cl. G01T 1/24

(52) U.S. Cl. 250/370.06; 250/370.01

(57) ABSTRACT

The invention relates to a spectrometric detection system comprising a block (6) of semi conducting material, a cathode (7) fixed on the first face of the block of semi conducting material, and an anode (8) fixed on a second face of the block of semi conducting material, the first and second faces being opposite to each other.

The detection system comprises a substrate (9) fixed on the anode (8) and at least one ASIC circuit (10, 11) implanted in the substrate, the ASIC circuit (10, 11) comprising electronics for processing a signal output from the block of semi conducting material.

The invention is applicable to any domain which involves the detection of ionizing radiation using semiconductors, for example medical imagery.

### TECHNICAL FIELD AND PRIOR ART

The invention relates to an integrated semiconductor-based spectrometric detection system.

The invention is applicable to detection of ionizing radiation using semi conducting components. The semiconductors used may for example be CdZnTe, CdTe:Cl or CdTe:In, GaAs, HgI₂, PbI₂, TlBr.

There are many advantages in the use of semiconductors as radiation detectors, including:

direct conversion of radiation into an electrical signal, rather than an indirect conversion of gamma photons/light/electrical charges obtained by the combination of a scintillator and a photo multiplier,

operation at ambient temperature, so that compact lightweight detectors can be designed,

electrical signals detected with high amplitude to obtain excellent energy resolutions,

the possibility of using thick detectors and being able to arrange these detectors in matrix form for better sensitivity.

In the last few years, control of firing of a semi conducting material associated with the spectrometric detectors manufacturing technology has justified the ambitions to use semiconductors in radiation spectrometry. The application field for semiconductor-based detectors has become much wider; two-dimensional imagers (2D imagers) in medical imagery based on a CdZnTe semiconductor, single-channel probes of the pre-operational probes type based on CdTe:Cl or CdZnTe, nuclear probes for checking irradiated assemblies, scientific instrumentation, etc.

Depending on the application field, incident radiation is composed of a variable number of photons with highly variable energies (from a few keV to several MeV). Detection systems must sometimes count these photons one by one and/or measure their energy as accurately as possible.

In general, a spectrometric detection system comprises:

a detector holder that keeps the detector in darkness and isolates it from electromagnetic disturbances,

a charge preamplifier that integrates the electrical signal generated by the semiconductor,

a low voltage preamplifier power supply,

a high voltage power supply to apply an electric field to the detector,

an amplifier to amplify, filter and process electrical signals output from the preamplifier,

a low voltage amplifier power supply,

an analog digital converter (ADC) to digitize electrical signals,

a low voltage converter power supply,

a spectrum analyzer,

a PC (Personal Computer) or counter type display unit.

Recent developments in the field of semiconductor-based detectors consisted of correcting the disadvantages usually associated with this type of material, for example such as trapping charge carriers. Trapping of charge carriers actually induces a loss of detection efficiency by making the measured electrical signal dependent on the place of interaction of the photon in the detector. Different compensation methods have been proposed, some associated with the electrode structure, others with electrical processing of signals. In all cases, the objective is to improve the detection efficiency while maintaining excellent energy resolution.

At the present time, single channel probe type gamma imagery systems or 2D imagers using semiconductor-based detectors are proposed with a hybrid architecture of the detection system. This hybrid architecture very significantly moves the semi conducting part away from the electronic processing part. This type of architecture has several disadvantages. It is fairly voluminous, which limits the compactness of 2D imager systems and single channel probes, and consequently very significantly reduces the application domains of this type of detector. This type of architecture cannot be used to easily make 2D imagers for which the elementary detectors have different dimensions. Furthermore, the connection between the semiconductor-based detector and the processing electronics is a source of noise that limits detector performances.

According to known art, proposed detector architectures comprise electronics in which the hybrid components are predominant. Only the preamplifier and the amplifier, and possibly the converter, are proposed in the form of an Application Specific Integrated Circuit (ASIC). Cables make electrical connections between the different elements forming the detection system.

Furthermore, integration of the preamplifier and the amplifier, or even the converter, into an ASIC circuit is not optimum. All existing system architectures propose a single ASIC circuit to manage several detectors. The ASIC circuit is then usually wired, glued or hybridized on a first face of a ceramic support, a matrix of individual detectors or a monolithic detector comprising several channels being glued onto the second face of this support.

An example of a hybrid architecture system according to known art is given in FIG. 1. The system comprises a set of elementary semiconductor-based detectors 1 installed on a connector 2. An ASIC circuit 4 installed on a support 3 is connected to connector 2. A set of pins 5 is connected to the inputs/outputs of the ASIC circuit 4.

The ASIC circuit 4 has very small dimensions (typically a few mm²), whereas the elementary detectors matrix 1 has a much larger electrodes surface area (typically a few tens of mm²). This large difference in dimensions leads to the presence of large electrical connections between the outputs from the elementary detectors 1 and the corresponding preamplifier inputs in the ASIC circuit 4. These connections are a source of noise, and particularly degrade detection performances.

The invention does not have the disadvantages mentioned above.

### PRESENTATION OF THE INVENTION

The invention relates to a spectrometric detection system comprising a semi conducting material block, a cathode fixed on a first face of the block of semi conducting material, and an anode fixed on a second face of the block of semi conducting material, the first and second faces being opposite to each other. The spectrometric detection system comprises a substrate fixed to the anode and at least one ASIC circuit implanted in the substrate, the ASIC circuit comprising signal processing electronics for a signal output from the block of semi conducting material.

The invention also relates to a single channel probe, characterized in that it comprises at least one spectrometric detection system according to the invention.

The invention also relates to a 2D imager, characterized in that it comprises several spectrometric detection systems according to the invention.

The spectrometric detection system according to the invention is thus a new system in which the semi conducting part and the electronic processing part are very close to each other. At least one ASIC circuit containing electronic processing circuits is placed close to the anode of an elementary detector, for example a CdZnTe detector.

The proximity between the semi conducting part and the processing electronics associated with it advantageously enables several features including:

it is easy to make different sizes of the 2D imager with different detector geometries and associated pitch geometries,

system performances are optimized by minimizing the electrical connection between the detector and the preamplifier,

the performances of 2D imagers can be optimized by making it possible to use a spectrometry system with each detector in order to improve the count rate.

According to one improvement of the invention, the electrode structure may advantageously introduce the capacitive effect commonly called the “Frish grid capacitive effect” which further improves the detection efficiency.

### BRIEF DESCRIPTION OF THE FIGURES

Other advantages and specificities of the invention will become clear upon reading a preferred embodiment with reference to the attached figures wherein:

FIG. 1 shows a spectrometric detection system according to known art;

FIG. 2 shows an example embodiment of the spectrometric detection system according to the invention;

FIGS. 3A-3B show a first component variant for spectrometric detection according to the invention;

FIGS. 4A-4B show a second component variant for spectrometric detection according to the invention;

FIGS. 5A-5B show a third component variant for spectrometric detection according to the invention;

FIG. 6 shows an improvement to the component according to the first variant of the invention;

FIG. 7 shows a single channel probe according to the invention;

FIG. 8 shows a 2D imager according to the invention.

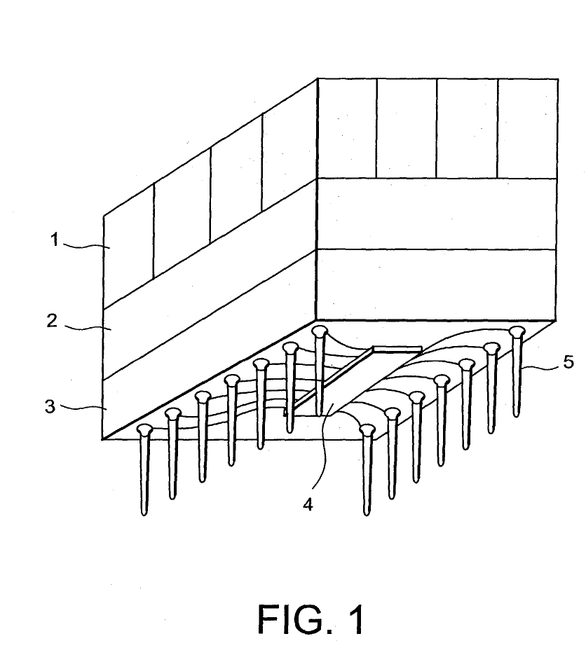

The same marks denote the same elements in all the figures.

### DETAILED DESCRIPTION OF EMBODIMENTS OF THE INVENTION

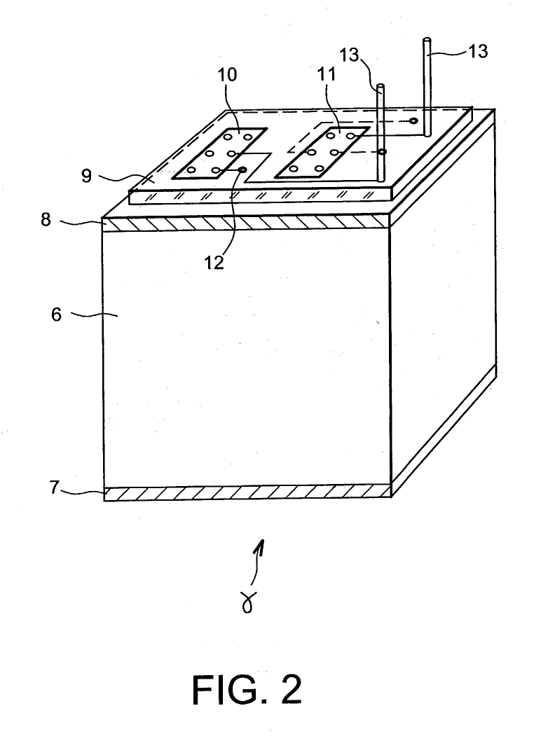

FIG. 2 shows an example embodiment of the spectrometric detection system according to the invention.

A block of semi conducting material 6, for example a block of CdZnTe, is covered on a first face by a cathode 7 and on a second face opposite the first face, by an anode 8. The anode 8 is covered by a thin substrate 9 on which two ASIC circuits 10 and 11 are directly implanted. For example, the substrate 9 may be silicon or AsGa with a thickness of the order of 500 μm. The ASIC circuit 10 is a preamplifier and the ASIC circuit 11 is a high voltage power supply circuit for polarization of the semi conducting material. γ radiation is sent to cathode 7. The signal output from the detector block 6 is collected on a pin 12 that is connected to the input of the ASIC circuit 10. Pins 13 are connected to the inputs/outputs of ASIC circuits 10 and 11.

It is clear that the connection between the semi conducting part and the electronic part in this case is minimized, which has the effect of reducing noise in the detection system. For example, noise may be reduced by 10 to 50%.

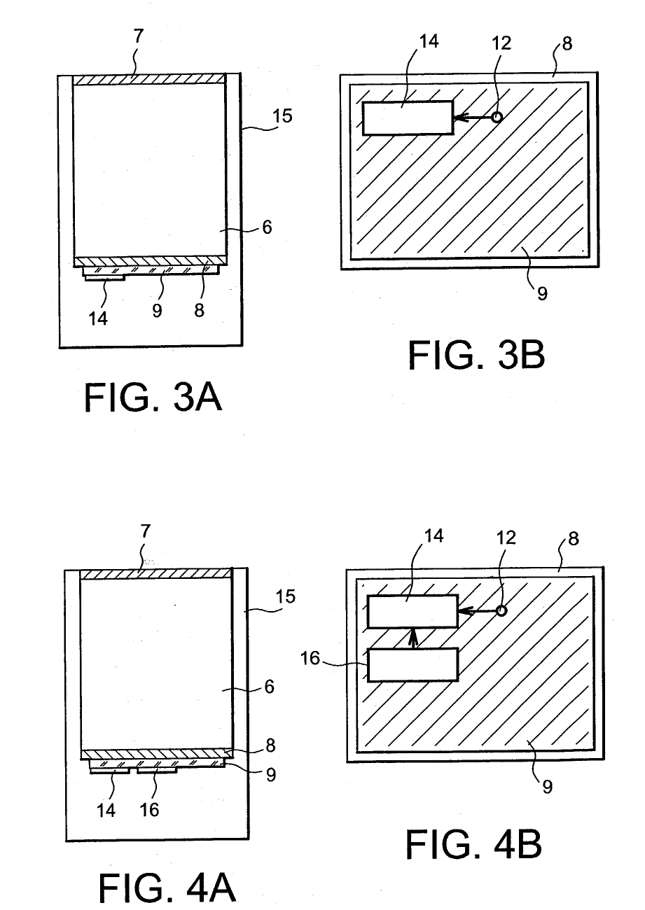

FIGS. 3A-3B show a first component variant for spectrometric detection according to the invention. FIG. 3A shows a sectional view of the component and FIG. 3B shows a top view of the component, on the anode side. The component according to the first variant of the invention comprises a block of semi conducting material 6, for example a block of CdZnTe, covered on a first face by a cathode 7 and on a second face opposite the first face by an anode 8. The anode 8 is covered by a thin substrate 9 in which an ASIC circuit 14 is implanted.

For example, the ASIC circuit 14 is an integrated circuit comprising a preamplifier, an amplifier and an analog/digital converter. A pin 12 collects the signal output from the detector 6. The different elements that form the component are collected together in a package 15 in which an opening is formed through which the cathode can be exposed to radiation.

The amplifier contained in the ASIC circuit 14 may advantageously comprise an electronic processing circuit to improve the detection efficiency, like the circuit described in French patent No. 2 738 919 deposited in France on Sep. 15, 1995 and entitled “Process and device for correction of spectrometric measurements”.

FIGS. 4A-4B show a second component variant for spectrometric detection according to the invention. In addition to the elements mentioned above, the component according to the second example of the invention comprises a second ASIC circuit 16. The ASIC circuit 16 is a high voltage power supply circuit that applies an electrical field in the semi conducting material. The ASIC circuit 16 is made using a silicon on insulator (SOI) technology, which makes it possible to create a power supply with polarization voltages of the order of a few hundred volts. The ASIC circuit 16 is implanted in the substrate 9, for example the silicon substrate.

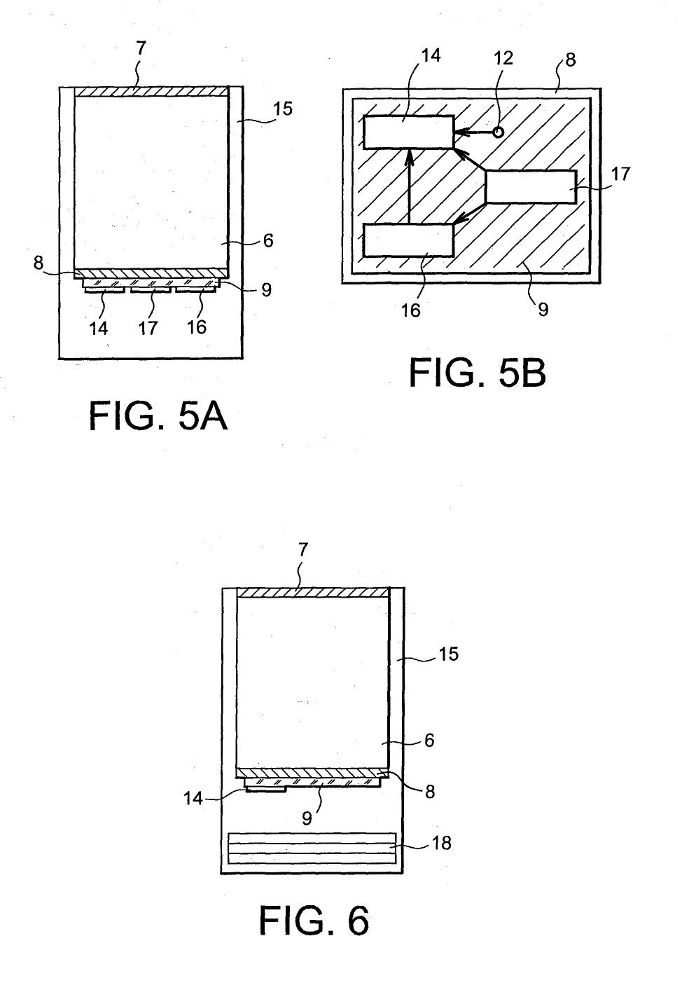

FIGS. 5A-5B show a third variant of the component for spectrometric detection according to the invention. In addition to the elements mentioned above for creation of a component conform with FIGS. 4A-4B, the component according to the third variant of the invention comprises a third ASIC circuit 17. For example, the ASIC circuit 17 can be used for electromagnetic transmission of detected data to circuits on the input side of the processing system, for example reception circuits located in a personal computer. Any electrical connection by cable between the detector and the personal computer is then advantageously deleted.

FIG. 6 shows an improvement to the first variant of the component according to the invention. In addition to the elements that make up the component according to the first variant, the component according to the improvement comprises a low voltage power supply block 18. The block 18 is composed of high capacity batteries in order to supply the ASIC circuit 14 at 0/+5 volts. The block 18 is fixed, for example by gluing, as close as possible to the ASIC circuit 14. It is then placed on the wall of the package facing the detector anode, as shown in FIG. 6.

The improvement is described above with reference to the first variant of the component according to the invention. It is obvious for those skilled in the art that this improvement may also be applied to components according to the second and third variants.

In general, the component according to the invention comprises one or several ASIC circuit(s) and/or power supply block type integration elements. The number of integration elements then depends on the required degree of integration. In all cases, integration of the ASIC circuit 14 is of prime importance in optimizing detector performances.

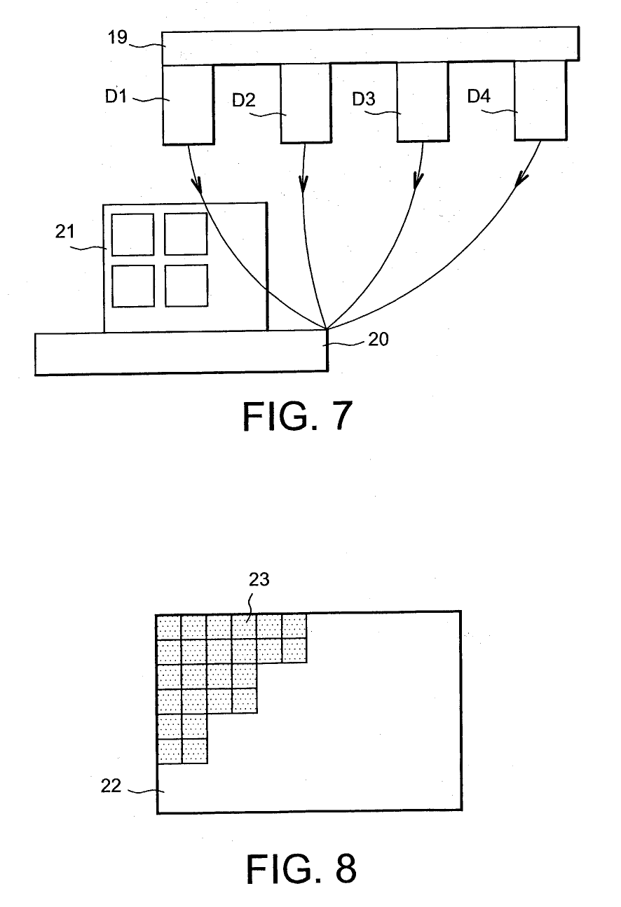

FIG. 7 shows a single channel probe according to the invention. A source of gamma radiation 19 illuminates four detectors according to the invention, D1, D2, D3, D4. Each detector Di (i=1, 2, 3, 4) is glued as close as possible to the sources and comprises an ASIC circuit 18 that enables it to transmit detected data by radio. The transmitted data are collected by a receiver block 20 and are displayed on a screen 21. The single channel probe is advantageously integrated into a few cm³ without any electrical connections.

Concerning 2D imagers, apart from the drastic increase in spectrometric performances, the different components may be connected on a small electronic support using pins. This enables flexibility in the definition of the 2D imager detection field by optimizing the geometry of the detectors and their pitch depending on the application field. A 2D imager 22 comprising a set of elementary detection systems connected together as close as possible is shown in FIG. 8.

1. Spectrometric detection system comprising a block (6) of semi conducting material, a cathode (7) fixed on a first face of the block of semi conducting material, and an anode (8) fixed on a second face of the block of semi conducting material, the first and second faces being opposite to each other, characterized in that it comprises a substrate (9) fixed to the anode (8) and at least one ASIC circuit (14) implanted in the substrate, the ASIC circuit (14) comprising signal processing electronics for a signal output from the block of semi conducting material.

2. Spectrometric detection system according to claim 1, characterized in that the ASIC circuit (14) comprises a preamplifier and an amplifier to preamplify and amplify the signal output from the block (6) of semi conducting material, respectively.

3. Spectrometric detection system according to claim 2, characterized in that the ASIC circuit (14) also comprises an analog/digital converter to convert the signal output from the amplifier into digital data.

4. Spectrometric detection system according to claim 3, characterized in that it also comprises an ASIC circuit (17) for electromagnetic transmission of digital data, fixed on the substrate (9).

5. Spectrometric detection system according to claims 1, characterized in that it also comprises a high voltage power supply ASIC circuit (16) implanted in the substrate (9), to apply an electric field in the semi conducting material.

6. Spectrometric detection system according to claim 5, characterized in that the high voltage power supply ASIC circuit (16) is made using a SOI technology.

7. Spectrometric detection system according to claim 1, characterized in that it also comprises a low voltage power supply block (18).

8. Spectrometric detection system according to claim 1, characterized in that it is included in a package (15).

9. Spectrometric detection system according to claim 8, characterized in that a low voltage power supply block (18) is fixed on a face of the package close to the anode (8).

10. Single channel probe, characterized in that it comprises at least one spectrometric detection system according to any one of claims 1 to 9.

11. 2D imager, characterized in that it comprises several spectrometric detection systems according to any one of claims 1 to 9.
